(19) United States
(12) Patent Application Publication
(10) Pub. No.: US 2008/0105197 A1
(43) Pub. Date: May 8, 2008

(54) Device for Applying a Coating Material to a Paper Web

(76) Inventors: Walter Muller, Reichsdorf (DE); Heinrich Kuschnik, Dusseldorf (DE); Udo Unger, Leichlingen (DE)

Correspondence Address: K.F. ROSS P.C., 5683 RIVERDALE AVENUE, SUITE 203 BOX 900, BRONX, NY, 10471-0900, US

(21) Appl. No.: 11/793,547

(22) PCT Filed: Dec. 16, 2005
(86) PCT No.: PCT/EP05/13576

§ 371 Date: Jun. 18, 2007

(30) Foreign Application Priority Data
Dec. 22, 2004 (DE) 10 2004 063 043.7

(51) Int. Cl. B05C 1/08

(52) U.S. Cl. 118/244

(57) ABSTRACT

The invention relates to a device for applying a coating material, which consists of a liquid resin and a fine-particled abrasive material, to a continuously impregnated paper web which is used in the production of abrasion-resistant laminates. Said device comprises a deflection roller whereon the paper web is arranged in the contact area, a dosing roller which is arranged in a parallel manner on the deflection roller, a narrow gap which encompasses said two rollers, and an application unit. Known application units comprise slot nozzles through which the treatment material is injected into the paper web. The problem thereof is that a complete cross-linking of the paper web is difficult to obtain and the treatment material is injected, in excess into the paper web. The aim of the invention is to overcome said problems. According to the invention, the application unit comprises a defining element which is arranged in the running direction of the web upstream from the gap, and enables a gore to be formed between the deflection roller and the defining element in order to receive the coating material. The invention also relates to the impregnation of paper for producing highly abrasion-resistant laminate.

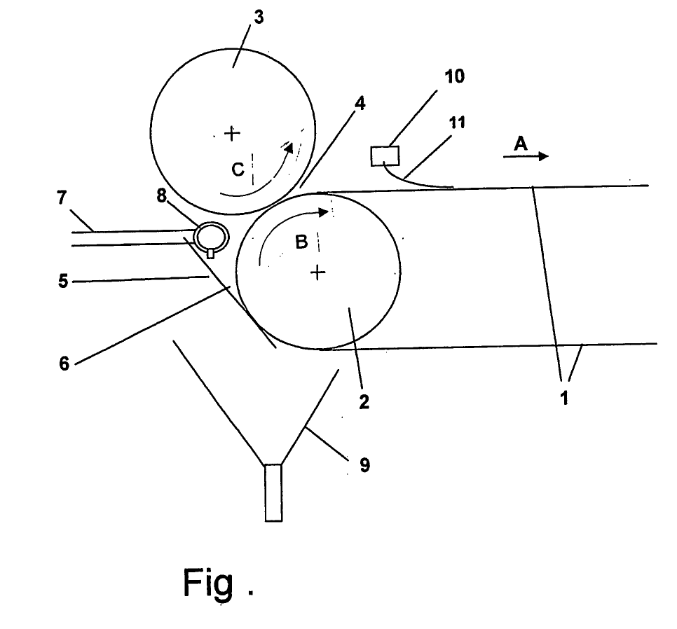

The invention relates to an apparatus for applying a coating material composed of liquid resin and fine-grain abrasive material to a continuous pre-impregnated paper web according to the preamble of claim 1. Corundum, for example, is used as the abrasive material. A problem in the use of such a coating material is the tendency of the corundum particles to deposit, i.e. to separate from the coating material.

DE 195 08 797 C describes a method for producing decorative paper for abrasion-resistant laminates. A viscous mixture composed of melamine resin, corundum particles, and alpha-cellulose as coating material is applied to the visible surface of a decorative paper. The alpha-cellulose is used as a reinforcing and suspending agent. The corundum particles have a grain size of 15 to 50 μm. The application quantity is 80 to 200 g/m², so that a layer thickness of 20 to 65 μm is obtained after drying. The coating material is applied by means of a wire doctor blade, screen roller, or reverse coating system. It has been shown that the components of such application systems that come into contact with the coating material are worn out by the abrasive corundum particles within a very short time.

To avoid excessive wear, it is known from DE 196 43 742 A to use a slotted nozzle for applying a coating material containing fine-grain abrasive material. The coating material is applied in excess as a thin film on the paper web. The apparatus described in DE 196 43 742 A prevents separation resulting from sedimentation of the fine-grain material.

A generic apparatus is known from EP 1 084 298 B [U.S. Pat. No. 6,432,201] for applying a coating material to a paper web pre-impregnated with resin and optionally also dried, in which an applicator likewise has a slotted nozzle. This apparatus is provided with a deflection roller against which the paper web rests in a contact region and a dosing roller that is positioned parallel to the deflection roller and that together with the deflection roller defines a narrow gap. The slotted nozzle is situated on the deflection roller or on the dosing roller.

A method for impregnating decorative papers is known from EP 1 068 394 B [U.S. Pat. No. 6,835,421], in which a layer of a coating material composed of amino resin and particulate abrasive material is sprayed onto an impregnated wet decorative paper. The cited document also states that by use of the spray principle, in which the coating material containing corundum particles, for example, is circulated and uniformly agitated, deposits are not observed.

Admixture of viscosity-increasing substances may be omitted. Aluminum oxide and/or silicon carbide having a grain size of 60 to 160 μm may be used as particle-form abrasive material.

When nozzles are used, for example as described in DE 196 43 742 A, measures must be taken to avoid separation of the coating material. In addition, ensuring that the paper web is completely wetted is problematic when the coating material is applied via a nozzle. For this reason, when a nozzle is used the coating material is sprayed onto the paper web in a large excess, specifically, in quantities 10 to 50 times greater than necessary for the desired layer thickness. A large portion of the sprayed coating material flows back directly into a collection trough. The circulation system must have a correspondingly large design, and entails correspondingly high capital and energy costs.

The object of the present invention is to develop an apparatus for applying a coating material to a continuous paper web according to the preamble of claim 1, in which separation of the coating material is avoided and complete wetting of the paper web is ensured, and in which the operation can be carried out with a low excess of coating material. A further aim is that the apparatus be less susceptible to wear.

The object is achieved by the characterizing features of claim 1.

According to the invention, the applicator of the apparatus contains a limiting element that is provided upstream from the gap in the direction of travel of the web and that forms a V-shaped trough between the deflection roller and the limiting element for receiving the coating material. The coating material is poured into this V-shaped trough. The coating material is taken up by the paper web running through the V-shaped trough, conveyed to the gap between the dosing roller and the deflection roller, and at the outlet of the gap is adjusted to the desired quantity, a portion of the coating material being returned from the dosing roller to the gap and the remainder remaining as a layer on the paper web. To this end, the paper web receives only a one- to three-fold excess of coating material from the V-shaped trough. The quantity of coating material is less than the quantity that adheres during spraying, and is significantly less than the quantity emitted by a slotted nozzle. The excess accumulates upstream from the gap and is able to flow back into the V-shaped trough.

The loading of the coating material in the V-shaped trough, which occurs similarly as for passage of the paper web through a coating material reservoir, ensures complete wetting of the paper web in a simple manner.

A quantity of coating material that is only slightly greater than that needed may be dosed into the V-shaped trough. This allows the container, conduits, and circulation pump to have a smaller size, thereby reducing the capital costs and energy requirements. Furthermore, there are no movable components on the applicator that might be exposed to severe wear. The limiting element that forms the V-shaped trough is a very simple component that can be easily replaced as needed.

The coating material is forcibly mixed in the V-shaped trough as a result of the motion of the paper web. Any slight deposition of corundum particles in the V-shaped trough results not in depletion but, rather, in enrichment of the corundum particles in the coating material received by the paper web. The reason is that any corundum particles deposited in the V-shaped trough are transferred to the paper web.

One particular advantage of an apparatus according to the invention is that on account of its simplicity the apparatus may be used in many ways. The apparatus is suitable for impregnation of decorative paper as well as overlay paper. The paper web to be coated may be pre-impregnated by applying resin and dosing the resin quantity using dosing rollers or a doctor blade, for example, and immediately providing the wet paper web with coating material. Alternatively, a pre-impregnated paper web may be dried before the coating material is applied. Viscosity-increasing substances such as alpha-cellulose, for example, may be omitted in the coating material. However, such materials may also be easily admixed. Any known particles, for example abrasive particles composed of aluminum oxide and/or silicon carbide having a grain size of 15 to 200 μm, may be used as abrasive material. The thickness of the coating may be 20 to 250 μm.

The subclaims relate to advantageous embodiments of the invention.

According to claim 2, the limiting element at its lower edge engages sealingly with the paper web, thereby ensuring that the corundum particles are completely received by the paper web. It is advantageous for the ends of the V-shaped trough to remain open so that a certain excess of coating material may drain off. A control system that precisely adjusts the quantity of resin to the required quantity is not necessary.

Alternatively, according to claim 3 the limiting element at its lower edge together with the paper web may form a narrow gap having a width of 0.05 to 1 mm, for example. Depending on the speed of the web, up to a certain gap width the coating material is carried from the gap by the paper web, so that the coating material does not flow through the gap. Complete entrainment occurs, for example, at a web speed of 60 m/min up to a gap width of approximately 0.3 mm. Greater gap widths of 0.3 to 1 mm, for example, allow a consistently low flow of coating material through the V-shaped trough, and thus a certain measure of circulation.

According to claim 4, the limiting element is designed as a substantially flat part oriented at an acute angle with respect to the vertical, and therefore as a simple component, and is situated upstream of the deflection roller.

According to claim 5, the dosing roller may be offset vertically relative to the deflection roller. This allows a simple mounting of the limiting element.

The dosing roller and the deflection roller are designed to be driven in opposite directions according to claim 6, which allows both rollers to move in the direction of travel of the web, thus permitting the coating material to be dosed with less risk of wear on the rollers.

Alternatively, according to claim 7 the dosing roller and the deflection roller may be designed to be driven in the same direction. This allows the surface of the received layer to be smoothed by the dosing roller, which is rolling opposite the direction of travel of the web.

According to claim 8 a smoothing unit is provided downstream from the dosing roller, thereby allowing the surface of the received layer to be smoothed, and is particularly advantageous for a dosing roller that according to claim 6 rolls in the direction of travel of the paper and detaches from the layer remaining on the paper web.

An apparatus according to the invention for applying a coating material composed of liquid resin and fine-grain abrasive material to a pre-impregnated paper web 1 comprises a deflection roller 2, a dosing roller 3, and an applicator. According to the figure, the paper web 1 is fed in the horizontal direction to the deflection roller 2 and rests against same in a contact region, specifically, in the region of an arc length of 180°. It is subsequently fed in the horizontal direction, as indicated by arrow A, to a dryer (not illustrated).

The deflection roller 2 is rotatably supported by its horizontal axis in an unillustrated machine frame. The dosing roller 3 is rotatably supported in the upper part of the contact region, near the deflection roller 2, in such a way that the rotational axes of the deflection roller 2 and of the dosing roller 3 are parallel, and a narrow gap 4 is formed between them. This gap 4 has a width of 0.05 to 0.5 mm, for example. The rotational axis of the dosing roller 3 is above that of the deflection roller 2; i.e. the dosing roller 3 is offset vertically relative to the deflection roller 2. The bearing of one of the rollers 2 or 3 is displaceable parallel to a line connecting the rotational axes of the rollers, thus allowing the width of the narrow gap 4 between the rollers 2 and 3 to be modified. The dosing roller 3 is provided with a smooth outer surface.

The deflection roller 2 and the dosing roller 3 are each connected to a drive such that the rotational directions of the rollers (arrows B and C) have the same direction as the direction of travel of the paper web 1. In other words, the two rollers 2, 3 themselves are driven in opposite directions. The drives for the two rollers 2 and 3 are mechanically or electrically coupled in such a way that the rollers 2 and 3 revolve in a synchronous or approximately synchronous manner.

The applicator has a limiting element 5 that is positioned beneath the dosing roller 3 in such a way that a V-shaped trough 6 is formed between the deflection roller 2 and the limiting element 5. For this purpose, the limiting element 5 is designed as a substantially planar part and extends parallel to the deflection roller 2. The limiting element 5 is a planar sheet fabricated from metal, for example stainless steel, and in the contact region in front of the deflection roller 2 is oriented at an acute angle with respect to the vertical. The lower end of the limiting element 5 is positioned close enough to the sleeve of the deflection roller 2 that it contacts the paper web 1, thereby closing the V-shaped trough 6 from below. The lower edge of the limiting element 5 extends outward at least several millimeters beyond the contact line with the paper web 1; i.e. the limiting element is oriented tangentially with respect to the paper web 1. The V-shaped trough 6 is open at the sides, i.e. at both ends of the limiting element 5.

The applicator also has a feed conduit 7 for the coating material and a manifold 8 into which the feed conduit 7 flows. The manifold 8, which likewise extends parallel to the deflection roller 2, is located in the upper region of the V-shaped trough 6, and has spaced holes on its underside.

The applicator also includes a collection trough 9, located beneath the deflection roller 2, as well as means (not illustrated) for a circulation system for the coating material, including a supply reservoir, pump, and conduits to which the collection trough 9 and feed conduit 7 are connected. A bypass system may optionally be provided for the V-shaped trough 6.

A smoothing unit comprising a retaining strip 10 that extends parallel to the deflection roller 2 and a rectangular sheet 11 made of flexible, rubber-like material is provided downstream from the dosing roller (in the direction of travel of the web) and above the paper web 1, in this example above the deflection roller 2. The sheet 11 is attached at its upstream edge to the retaining strip 10 in such a way that a strip-shaped section of the sheet 11 loosely rests on the top face of the paper web 1 running out from the deflection roller 1 [sic; 2]. The sheet 11 extends over the entire width of the paper web 1. The design of the retaining strip 10 and the sheet 11 corresponds to the design described in EP 1 084 298 B.

In operation, the paper web 1 is fed from below to the deflection roller 2 in the horizontal direction at a web speed between approximately 10 and 70 m/min, for example 50 m/min, and proceeds further to the dryer in an approximately horizontal direction indicated by arrow A. The coating material containing the homogeneously distributed abrasion-resistant particles is dosed into the V-shaped trough 6 through the feed conduit 7 and the manifold 8. In the V-shaped trough 6 the coating material is distributed essentially uniformly over the width of the paper web 1. At a minimum, the supplied quantity corresponds as closely as possible to the predetermined target quantity according to a selected coating thickness. Small quantities of excess coating material may possibly flow out the open ends of the V-shaped trough 6, and are collected in the collection trough 9 and returned to the supply reservoir.

The paper web 1 receives the coating material from the V-shaped trough 6. The coating material is received in a one- to three-fold excess, i.e. with a much lower excess than for spraying of the paper web 1. When running through the narrow gap 4, the width of which is set corresponding to the desired coating thickness, the coating material that adheres to the paper web 1 is dosed. Excess coating material, specifically, coating material that is retained upstream from the gap 4 and entrained by the dosing roller 3, accumulates upstream from the gap 4 and flows back into the V-shaped trough 6. A small portion of the coating material entrained by the dosing roller 3 may drip into the trough 9 and be recirculated with the remaining coating material.

If necessary, a portion of the coating material may be circulated through the bypass system, so that the entire recirculated quantity may be three to ten times greater than that required. This recirculated quantity is also much less than that necessary when slotted nozzles are used.

Detachment of the coating material adhering to the paper web 1 from the surface of the dosing roller 3 at the outlet of the gap 4 may result in slight irregularities in the layer, such as longitudinal strips. Such irregularities are smoothed out by the subsequent sheet 11 resting on the surface of the layer.

The paper web 1 thus coated is then dried to a predetermined residual moisture in the dryer, and is then wound on a roll or cut into sheets, for example.

In one alternative embodiment, the feed conduit 7 and the manifold 8 may be replaced by multiple spaced-apart feed conduits that open into the upper region of the V-shaped trough 6.

In a further alternative embodiment, the limiting element 5 is positioned such that together with the paper web 1 it forms a narrow gap of 0.05 to 1 mm. In this embodiment the V-shaped trough 6 may be closed off at the ends by lateral sheets. In operation, a small quantity of coating material continuously flows through this gap in the V-shaped trough 6 and drips into the trough 9.

In a further alternative embodiment, the drives for the deflection roller 2 and the dosing roller 3 are connected in such a way that the direction of rotation of the dosing roller 3 is opposite to that of the deflection roller 2 and to the direction of travel of the web. Since in this embodiment the dosing roller 3 smooths the surface of the layer, the smoothing unit may optionally be omitted.

Alternatively, the limiting element 5 and optionally elements on the sides may be made of plastic, for example Teflon.

1. An apparatus for applying a coating material composed of liquid resin and abrasive material to a continuous pre-impregnated paper web that is intended for use in the manufacture of abrasion-resistant laminates, comprising a deflection roller against which the paper web rests in a contact region, a dosing roller that is positioned parallel to the deflection roller and that a together with the deflection roller defines a narrow gap, and an applicator wherein the applicator contains a limiting element, provided upstream from the gap in the direction of travel of the web, which forms a V-shaped trough between the deflection roller and the limiting element for receiving the coating material.

2. The apparatus according to claim 1 wherein the limiting element at its lower end is situated in a sealing manner with respect to the paper web.

3. The apparatus according to claim 1 wherein the limiting element at its lower end together with the paper web forms a narrow gap.

4. The apparatus according to claim 1 wherein the limiting element is designed as a substantially flat component, and in the contact region is oriented at an acute angle with respect to the vertical, in front of the deflection roller.

5. The apparatus according to claim 1 wherein the dosing roller is offset-in height in relation to the deflection roller.

6. The apparatus according to claim 1 wherein the dosing roller and the deflection roller may be driven in opposite directions.

7. The apparatus according to claim 1 wherein the dosing roller and the deflection roller may be driven in the same direction.

8. The apparatus according to claim 1 wherein a smoothing unit is provided downstream from the dosing roller.
